(19) United States
(12) Patent Application Publication
(10) Pub. No.: US 2009/0297773 A1
(43) Pub. Date: Dec. 3, 2009

(54) OPTICAL FILM HAVING NON-SPHERICAL PARTICLES

(75) Inventor: YI-CHIA WANG, Kaohsiung (TW)

Correspondence Address: LADAS & PARRY LLP, 26 WEST 61ST STREET, NEW YORK, NY, 10023, US

(73) Assignee: ETERNAL CHEMICAL CO., LTD..

(21) Appl. No.: 12/491,379

(22) Filed: Jun. 25, 2009

(30) Foreign Application Priority Data
Jun. 26, 2006 (TW) 097123833

(51) Int. Cl. B32B 5/16

(52) U.S. Cl. 428/147; 428/141

(57) ABSTRACT

The subject invention pertains to an optical film comprising a flexible substrate, a first surface comprising a convex-concave microstructure, and a second surface comprising a resin coating, wherein the resin coating comprises non-spherical particles and the non-spherical particles have a longest dimension in the range from 1 μm to 20 μm and an aspect ratio in the range from 1.2 to 1.8.

The resin coating has excellent antistatic properties and a high hardness so as to prevent the optical film of the subject invention from being scratched or damaged or the adhesion of dust during transportation or processing.

### BACKGROUND OF THE INVENTION

1. Field of the Invention

The present invention relates to an optical film comprising a resin coating containing non-spherical particles. The optical film of the present invention is useful in light source devices and provides the efficacy of enhancing brightness.

2. Description of the Prior Art

Brightness enhancement is very important to many light source devices, such as advertising light boxes and backlight modules of flat panel displays. If many light sources are used, excessive energy will be consumed and green standards may not be met. Various optical films are therefore commonly used in light source devices to enhance brightness and maximize efficiency without altering element design or consuming additional energy. This approach has become the most economical and convenient solution.

Common optical film comprises at least a substrate and an optical layer, which can enhance optical properties such as light focus or uniformity. To avoid adsorption of optical film with other films or elements occurring during the transportation or cutting process and to prevent the optical film from being scratched or damaged, a resin coating containing particles is usually applied on the other surface of the optical film. The application of a resin coating containing particles also enhances light diffusion. Spherical particles are usually used in the art to prepare the resin coating. However, spherical particles are liable to aggregate or adhere with each other, resulting in reduced light transmittance and luminance.

The present invention provides an optical film to overcome the above disadvantages. The optical film of the present invention substitutes non-spherical particles for conventional spherical particles to prepare the resin coating. As compared to conventional optical films, the optical film of the present invention enhances light transmittance and avoids light waste, thereby enhancing the luminance of the optical film. Furthermore, non-spherical particles are less likely to drop off, so light diffusion does not become reduced and the original optical properties will not be adversely affected. Therefore, the purpose of the present invention can be achieved.

### SUMMARY OF THE INVENTION

The present invention pertains to an optical film comprising a flexible substrate, a first surface having a convex-concave microstructure, and a second surface comprising a resin coating, wherein the resin coating comprises non-spherical particles and the non-spherical particles have a longest dimension in the range from 1 μm to 20 μm and an aspect ratio in the range from 1.2 to 1.8.

### BRIEF DESCRIPTION OF THE DRAWINGS

FIG. 1 is a schematic view of a non-spherical particle according to one preferred embodiment of the present invention.

FIGS. 2 to 11 illustrate the optical films according to the preferred embodiments of the present invention.

### DETAILED DESCRIPTION OF THE INVENTION

The term “aspect ratio” used herein is well known to persons having ordinary skill in the art. It refers to the ratio of the longest dimension to the shortest dimension of a non-spherical particle. For example, when the non-spherical particle is a disk-like particle, the longest dimension among all of the dimensions refers to the diameter of the particle and the aspect ratio refers to the ratio of the diameter of the particle to the thickness of the particle; when the non-spherical particle is a rice-like particle, the longest dimension among all of the dimensions refers to the length of the particle and the aspect ratio refers to the ratio of the length of the particle to the diameter of the largest cross-section of the particle.

The term “flexible substrate” used herein refers to a substrate that can be curled, and when being curled (for example, being curled into a cylinder with a diameter as small as 1 cm), it does not have observable discontinuous points (for example, kinks, fragments, or segments) on the surface.

The optical film according to the present invention comprises a flexible substrate. The first surface of the substrate has a convex-concave microstructure and the second surface of the substrate comprises a resin coating, wherein the resin coating comprises non-spherical particles and the non-spherical particles have a longest dimension in the range from 1 μm to 20 μm and an aspect ratio in the range from 1.2 to 1.8.

The flexible substrate used in the optical film of the present invention can be any flexible substrate known to persons having ordinary skill in the art, such as a plastic substrate. The plastic substrate can be composed of one or more polymer resin layers. The species of the resins used to form the polymer resin layers are not particularly limited, and can be, for example, but are not limited to: polyester resins, such as polyethylene terephthalate (PET) and polyethylene naphthalate (PEN); polymethacrylate resins, such as polymethyl methacrylate (PMMA); polyimide resins; polystyrene resins; polycycloolefin resins; polyolefin resins; polycarbonate resins; polyurethane resins; triacetate cellulose (TAC); polylactic acid (PLA); or a mixture thereof. Polyethylene terephthalate, polymethyl methacrylate, polycycloolefin resin, or triacetate cellulose, or a mixture thereof is preferred and polyethylene terephthalate is more preferred. The thickness of the substrate of the present invention is preferably in the range from about 16 μm to about 250 μm, usually depending on the desired purpose of an optical product.

The convex-concave microstructure on the first surface of the substrate can be a single-layer structure or a multiple-layer structure. The convex-concave microstructure of the present invention is used for imparting the optical film with the desired optical properties. The type of the convex-concave microstructure is not particularly limited and can be any of those known to persons having ordinary skill in the art, such as a diffusive structure for diffusing light or a light-converging structure for gathering light. The convex-concave microstructure and the substrate of the present invention can be formed integrally by, for example, an embossing process. Alternatively, the convex-concave microstructure can be formed by further processing the substrate by any conventional methods, for example, by coating the substrate so as to form a convex-concave microstructure layer directly, or applying a coating layer on the substrate and then carving the coating layer to form the desired convex-concave microstructure. The thickness of the convex-concave microstructure is not particularly limited. It depends on the size of the convex-concave microstructure and is generally in the range from about 1 μm to about 50 μm, preferably in the range from about 5 μm to about 30 μm, and more preferably in the range from about 15 μm to about 25 μm.

According to one preferred embodiment of the present invention, the convex-concave microstructure is a single-layer structure having a diffusion effect (i.e., a diffusive layer). The method to form said convex-concave microstructure can be any method that is well known to persons having ordinary skill in the art, which is for example, but not limited to screen printing, coating, embossing or spray coating. Preferably, said convex-concave microstructure is formed by applying a coating composition comprising diffusive particles and a binder onto one surface of the substrate. The species of the diffusive particles are not particularly limited, and can be for example, but are not limited to glass beads, particles of metal oxides, plastic beads, or a combination thereof. The species of the binder are not particularly limited, which can be any binder that is well known to persons having ordinary skill in the art. Furthermore, the shape of the diffusive particles is not particularly limited, which can be, for example, spherical, diamond-shaped, oval, rice-like or biconvex lenses-shaped, of which the spherical shape is preferred. The average particle size of the diffusive particles is ranging from about 1 μm to about 50 μm, preferably from about 5 μm to about 30 μm, and more preferably from about 8 μm to about 20 μm.

According to another preferred embodiment of the present invention, the convex-concave microstructure is a single-layer structure having light-converging effect (i.e., a light-converging layer). The convex-concave microstructure layer can be formed by any method that is well known to persons having ordinary skill in the art, for example, by slit die coating, micro gravure coating or roller coating, and by a roll-to-roll continuous process, such that a plurality of convex-concave microstructures, which can provide light-converging effect, is formed on the substrate. The convex-concave microstructures that can provide light-converging effect are known to persons having ordinary skill in the art, which can be for example, but are not limited to regularly or irregularly arranged, prism columnar structures (i.e., triangular columns), arc columnar structures (i.e., the columnar structures having round tops), conical columnar structures, solid angle structures, orange-segment like structures, lens-like structures, or capsule-like structures, or a combination thereof. Moreover, the prism columnar structures and arc columnar structures can be linear, zigzag, or serpentine, and two adjacent columnar structures can be parallel or non-parallel.

According to a further preferred embodiment of the present invention, the convex-concave microstructure is a multiple-layer structure providing both diffusion and light-converging effects. Such multi-layer structure can be formed by any method that is well known to persons having ordinary skill in the art. For example, it can be made by coating a convex-concave microstructure layer having diffusion effect (a diffusive layer) on the substrate first and then coating a convex-concave microstructure layer having light-converging effect (a light-converging layer) on the diffusive layer via a roll-to-roll continuous process. According to a preferred embodiment of the present invention, the diffusive layer comprises diffusive particles and the diffusive particles in the diffusive layer have a refractive index greater than that of the light-converging layer and the difference between the refractive index of the diffusive particles in the diffusive layer and that of the light-converging layer is in the range from about 0.05 to about 1.1. According to the present invention, the refractive index of the diffusive particles is preferably about 1.7 to about 2.5, more preferably about 1.9.

The second surface of the substrate of the present invention comprises a resin coating and the resin coating comprises non-spherical particles. The non-spherical particles have a longest dimension in the range from 1 μm to 20 μm, preferably from 2 μm to 12 μm, and more preferably from 3 μm to 8 μm, and an aspect ratio in the range from 1.2 to 1.8, preferably from 1.4 to 1.6. In general, when the non-spherical particles have a longest dimension less than 1 μm, the resin coating will not have sufficient surface roughness and cannot achieve the efficacy of light diffusion, and the particles are liable to adhere to each other such that the dispersibility thereof is poor, thereby affecting the optical properties. When the non-spherical particles have a longest dimension greater than 20 μm, the scratch resistance of the resin coating becomes worse, and the surface roughness is too large such that too much light will be scattered, thereby decreasing the luminance of the film. The thickness of the resin coating on the second surface of the substrate of the present invention is not particularly limited and usually depends on the desired purpose of the optical product. The thickness of the resin coating on the second surface of the substrate of the present invention is preferably in the range from about 0.5 μm to about 10 μm, preferably in the range from about 1 μm to about 5 μm. According to the present invention, the resin coating can be smooth or not and the non-spherical particles in the resin coating can have a portion of volume outside the resin coating or be totally encompassed within the resin coating.

The non-spherical particles used in the present invention can be, for example, but are not limited to disk-like particles, rice-like particles, oval particles, capsule-like particles, or biconvex lenses-shaped particles, of which the biconvex lenses-shaped particles are preferred. The species of the non-spherical particles are not particularly limited and can be organic or inorganic particles, of which organic particles are preferred. The organic particles can be, for example, polyacrylate resin, polystyrene resin, polyurethane resin, or silicone resin, or a mixture thereof, of which polyacrylate resin is preferred.

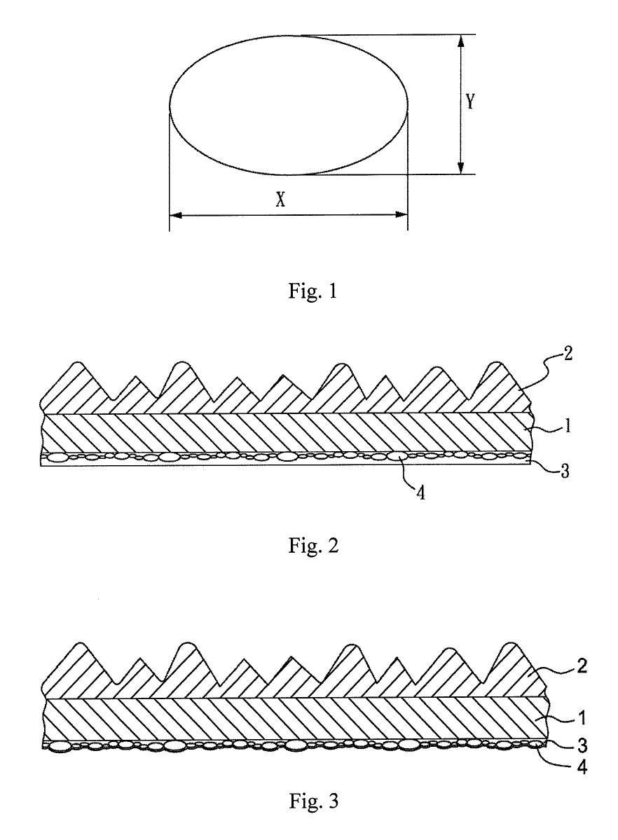

FIG. 1 is a schematic view of a non-spherical particle according to one preferred embodiment of the present invention. In this preferred embodiment, the non-spherical particle is a biconvex lenses-shaped particle wherein X is the longest dimension (i.e., the diameter in the direction of the longest axis) of the biconvex lenses-shaped particle, Y is the thickness of the biconvex lenses-shaped particle, and the aspect ratio corresponds to X/Y.

In addition to the non-spherical particles, the resin coating of the present invention further comprises a binder. The non-spherical particles in the resin coating of the present invention are present in an amount from about 0.1 to about 30 parts by weight, preferably from 1 to 5 parts by weight per 100 parts by weight of the solids content of the binder. The binder used in the resin coating of the present invention is preferably transparent and colorless. The binder of the present invention can be selected from the group consisting of an ultraviolet (UV) curable resin, a thermal setting resin, and a thermal plastic resin, and a mixture thereof, which is optionally processed by heat curing, UV curing, or heat and UV dual curing, so as to form the resin coating of the present invention. In an embodiment of the present invention, in order to enhance the hardness of the coating and prevent the film from warping, the binder contains a UV curable resin and a resin selected from the group consisting of a thermal setting resin and a thermal plastic resin and a mixture thereof, and is treated by heat and UV dual curing, so as to form a resin coating with excellent heat-resistant property and extremely low volume shrinkage.

The UV curable resin useful in the present invention is formed from at least one acrylic monomer or acrylate monomer having one or more functional groups, of which the acrylate monomer is preferred. The acrylate monomer suitable for the present invention includes, but is not limited to, a methacrylate monomer, an acrylate monomer, a urethane acrylate monomer, a polyester acrylate monomer, or an epoxy acrylate monomer, among which the acrylate monomer is preferred.

For example, the acrylate monomer suitable for the UV curable resin used in the present invention is selected from the group consisting of methyl methacrylate, butyl acrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, lauryl methacrylate, isooctyl acrylate, stearyl methacrylate, isodecyl acrylate, isobornyl methacrylate, benzyl acrylate, hydroxypivalyl hydroxypivalate diacrylate, ethoxylated 1,6-hexanediol diacrylate, dipropylene glycol diacrylate, tricyclodecane dimethanol diacrylate, ethoxylated dipropylene glycol diacrylate, neopentyl glycol diacrylate, propoxylated neopentyl glycol diacrylate, ethoxylated bisphenol-A dimethacrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate, diethylene glycol dimethacrylate, 2-hydroxyethyl methacrylate phosphate, tris(2-hydroxy ethyl)isocyanurate triacrylate, pentaerythritol triacrylate, ethoxylated trimethylolpropane triacrylate, propoxylated trimethylolpropane triacrylate, trimethylolpropane triacrylate, pentaerythritol tetraacrylate, ethoxylated pentaerythritol tetraacrylate, ditrimethylolpropane tetraacrylate, propoxylated pentaerythritol tetraacrylate, dipentaerythritol hexaacrylate, hydroxyethyl acrylate (HEA), 2-hydroxyethyl methacrylate (HEMA), tripropylene glycol dimethacrylate, 1,4-butanediol dimethacrylate, 1,6-hexanediol dimethacrylate, allylated cyclohexyl dimethacrylate, isocyanurate dimethacrylate, ethoxylated trimethylol propane trimethacrylate, propoxylated glycerol trimethacrylate, trimethylol propane trimethacrylate, and tris(acryloxyethyl)isocyanurate, and a mixture thereof. Preferably, the acrylate monomers contain dipentaerythritol hexaacrylate, trimethylolpropane triacrylate, and pentaerythritol triacrylate.

In order to improve the film-forming property of the resin coating, the UV curable resin used in the present invention can optionally contain an oligomer having a molecular weight in a range from 10³ to 10⁴. Such oligomers are well known to persons having ordinary skill in the art, such as, acrylate oligomers, which include, for example, but are not limited to urethane acrylates, such as aliphatic urethane acrylates, aliphatic urethane hexaacrylates, and aromatic urethane hexaacrylates; epoxy acrylates, such as bisphenol-A epoxy diacrylate and novolac epoxy acrylate; polyester acrylates, such as polyester diacrylate; or homo-acrylates.

The thermal setting resin suitable for the present invention typically has an average molecular weight in a range from about 10⁴ to about 2×10⁶, preferably from about 2×10⁴ to about 3×10⁵, and more preferably from about 4×10⁴ to about 10⁵. The thermal setting resin of the present invention can be selected from the group consisting of a carboxyl (—COOH) and/or hydroxyl (—OH) group-containing polyester resin, epoxy resin, polyacrylate resin, polymethacrylate resin, polyamide resin, fluoro resin, polyimide resin, polyurethane resin, and alkyd resin, and a mixture thereof, of which the polymethacrylate resin or polyacrylate resin containing a carboxy (—COOH) and/or hydroxyl (—OH) group is preferred, such as a polymethacrylic polyol resin.

The thermal plastic resin that can be used in the present invention can be selected from the group consisting of polyester resins; polymethacrylate resins, such as polymethyl methacrylate (PMMA); and a mixture thereof.

In addition to the non-spherical particles and the binder, the resin coating of the present invention may optionally contain any additives known to persons having ordinary skill in the art, which include, but are not limited to an anti-static agent, a curing agent, a photo initiator, a fluorescent whitening agent, a UV absorber, inorganic particulates, a wetting agent, a defoamer, a leveling agent, a flow agent, a slipping agent, a dispersant, or a stabilizing agent. The optical layer of the present invention may optionally contain any of the above additives, too.

During the manufacturing process of an optical film, static electricity will be generated by the friction of the resin materials themselves or between the resin materials and other materials. Therefore, an anti-static agent can be added to prevent the static electricity. One or more anti-static agents can be added when needed. The anti-static agent suitable for the present invention is not particularly limited, and can be any anti-static agent well known to persons having ordinary skill in the art, such as ethoxy glycerin fatty acid esters, quaternary amine compounds, aliphatic amine derivatives, epoxy resins (such as polyethylene oxide), siloxane, or other alcohol derivatives, such as poly(ethylene glycol) ester, poly(ethylene glycol) ether and the like.

The curing agent suitable for the present invention can be any curing agent well known to persons having ordinary skill in the art and capable of making the molecules to be chemically bonded with each other to form crosslinking, and can be, for example, but is not limited to polyisocyanate.

The fluorescent whitening agent suitable for the present invention is not particularly limited, and can be any fluorescent whitening agent well known to persons having ordinary skill in the art, which can be an organic, including, for example, but being not limited to a benzoxazole, benzimidazole, or diphenylethylene bistriazine; or an inorganic, including, for example, but being not limited to zinc sulfide.

The UV absorber suitable for the present invention can be any UV absorber well known to persons having ordinary skill in the art, for example, a benzotriazole, a benzotriazine, a benzophenone, or a salicylic acid derivative.

The photo initiator used in the present invention will generate free radicals after being irradiated, and initiate a polymerization through delivering the free radicals. The photo initiator suitable for the present invention is not particularly limited, and, the preferred photo initiator is benzophenone or 1-hydroxy cyclohexyl phenyl ketone.

Moreover, when the substrate is a plastic substrate, in order to prevent the plastic substrate from yellowing, inorganic particulates capable of absorbing UV light can be optionally added to the convex-concave microstructure or resin coating of the present invention. The inorganic particulates can be, for example, but are not limited to zinc oxide, strontium titanate, zirconia, alumina, silicon dioxide, titanium dioxide, calcium sulphate, barium sulfate, or calcium carbonate, or a mixture thereof, of which titanium dioxide, zirconia, alumina, zinc oxide, or a mixture thereof is preferred. The particle size of the above-mentioned inorganic particulates is typically in the range from about 1 nanometer (nm) to about 1000 nm, preferably from about 10 nm to about 500 nm, and more preferably from about 20 nm to about 200 nm.

The optical film of the present invention can be manufactured by any process well known to persons having ordinary skill in the art wherein the processes for preparing a convex-concave microstructure and a resin coating are as described hereinbefore. The order for preparing the convex-concave microstructure and the resin coating is not particularly limited. For example, a resin coating containing non-spherical particles is applied onto one surface of the substrate and then a convex-concave microstructure is applied onto the opposite surface of the substrate, and vice versa.

FIGS. 2 to 11 further illustrate the preferred embodiments of the optical films according to the present invention.

FIGS. 2 and 3 show two preferred embodiments of the optical films according to the present invention, wherein the first surface of the substrate 1 comprises a convex-concave microstructure 2 and the second surface of the substrate comprises a resin coating 3. The convex-concave microstructure 2 is composed of a plurality of prism columnar structures and arc columnar structures with different widths and heights, which provide light-converging effect, and the resin coating 3 contains a plurality of non-spherical particles 4. In the embodiment shown in FIG. 2, the resin coating 3 is smooth, and in the embodiment shown in FIG. 3, the resin coating 3 is non-smooth.

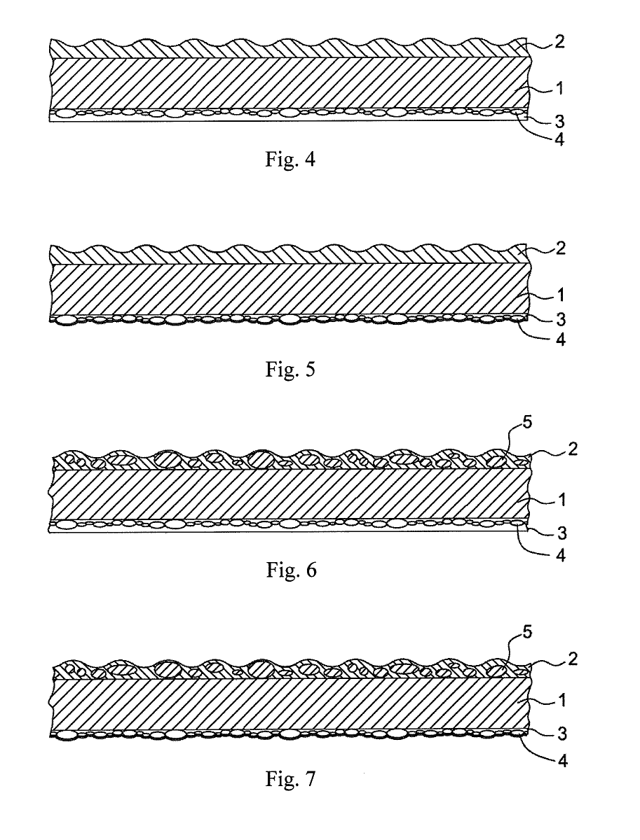

FIGS. 4 and 5 show another two preferred embodiments of the optical films according to the present invention, wherein the first surface of the substrate 1 comprises a convex-concave microstructure 2 and the second surface of the substrate comprises a resin coating 3. The convex-concave microstructure 2 is composed of a plurality of arc columnar structures, and the resin coating 3 contains a plurality of non-spherical particles 4. In the embodiment shown in FIG. 4, the resin coating 3 is smooth, and in the embodiment shown in FIG. 5, the resin coating 3 is non-smooth.

FIGS. 6 and 7 show two other preferred embodiments of the optical films according to the present invention, wherein the first surface of the substrate 1 comprises a convex-concave microstructure 2 and the second surface of the substrate comprises a resin coating 3. The convex-concave microstructure 2 contains a plurality of diffusive particles 5, and the resin coating 3 contains a plurality of non-spherical particles 4. In the embodiment shown in FIG. 6, the resin coating 3 is smooth, and in the embodiment shown in FIG. 7, the resin coating 3 is non-smooth.

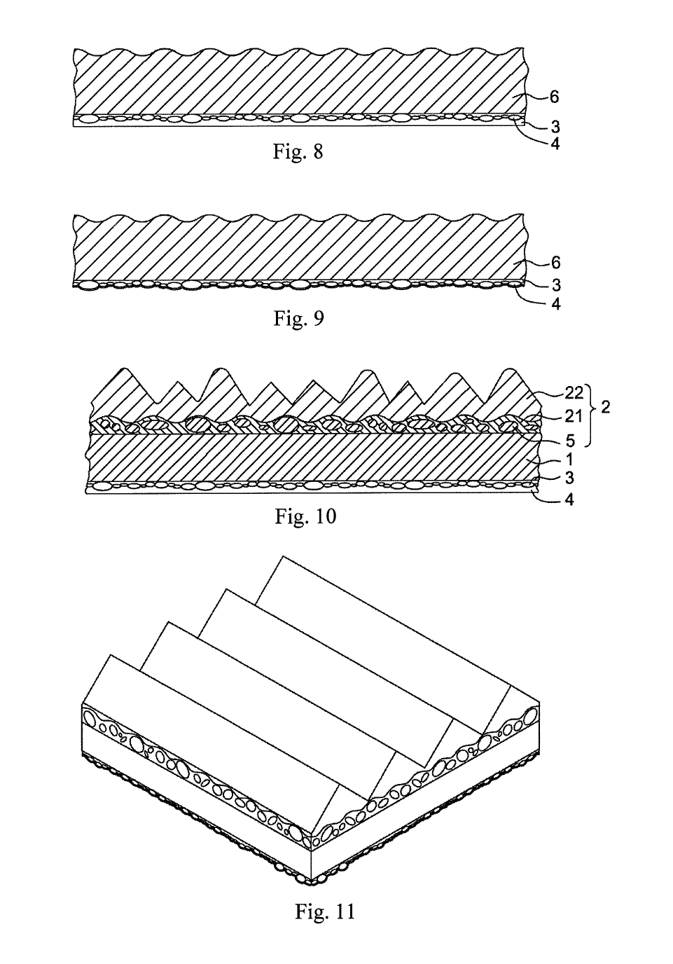

FIGS. 8 and 9 show two other preferred embodiments of the optical films according to the present invention, wherein the first surface of the substrate comprises a convex-concave microstructure, the convex-concave microstructure is formed integrally with the substrate (see symbol 6 in FIGS. 8 and 9), the second surface of the substrate comprises a resin coating 3, and the resin coating 3 contains a plurality of non-spherical particles 4. In the embodiment shown in FIG. 8, the resin coating 3 is smooth, and in the embodiment shown in FIG. 9, the resin coating 3 is non-smooth.

FIG. 10 shows another preferred embodiment of the optical film according to the present invention, wherein the first surface of the substrate 1 comprises a convex-concave microstructure 2, the convex-concave microstructure is an optical layer having both light diffusion and light-converging effects, the convex-concave microstructure comprises a diffusive layer 21 comprising a plurality of diffusive particles 5 and a light-converging layer 22 composed of a plurality of prism columnar structures and arc columnar structures with different widths and heights, the second surface of the substrate comprises a resin coating 3, and the resin coating 3 contains a plurality of non-spherical particles 4 and is smooth.

FIG. 11 is a stereographic view of another preferred embodiment of the optical film according to the present invention, wherein the first surface of the substrate 1 comprises a convex-concave microstructure 2, the convex-concave microstructure is an optical layer having both light diffusion and light-converging effects, the convex-concave microstructure comprises a diffusive layer 21 comprising a plurality of diffusive particles 5 and a light-converging layer 22 composed of a plurality of prism columnar structures with the same widths and heights, the second surface of the substrate comprises a resin coating 3, and the resin coating 3 contains a plurality of non-spherical particles 4 and is non-smooth.

The optical properties of an optical product can be expressed by its haze (Hz) and total transmittance (Tt). Haze is related to the light-scattering property of the optical product and total transmittance is related to the light-transmitting property of the optical product. According to the present invention, the resin coating on the second surface has a haze in the range from 1% to 90%, preferably from 5% to 50%, as measured according to JIS K7136 standard method in the absence of the convex-concave microstructure. Hence, the resin coating of the present invention is capable of scattering light. The total transmittance of the optical film of the present invention is measured according to JIS K7136 standard method. The optical film of the present invention has a total transmittance no less than 60%, preferably more than 80%, and more preferably 90% or more. In addition, the resin coating of the present invention has a surface resistivity in the range from 10⁸ to 10¹³Ω/□ (Ω/□ represents ohm/square), and a pencil hardness of 3H or more as measured according to JIS K5400 standard method.

According to one preferred embodiment of the present invention, the optical film of the present invention comprises a convex-concave microstructure on the first surface of the substrate and a resin coating on the second surface of the substrate, wherein the resin coating comprises non-spherical particles, a binder and an anti-static agent, and wherein the non-spherical particles have a longest dimension in the range from 3 μm to 8 μm and an aspect ratio in the range from 1.2 to 1.8 and the resin coating has a thickness of 1 μm to 5 μm and a pencil hardness of 3H or more as measured according to JIS K5400 standard method.

The optical film of the present invention can be used in light source devices, for example, advertising light boxes and flat panel displays, particularly in backlight modules for liquid crystal displays. The optical film of the present invention is coated with a resin coating comprising non-spherical particles on the second surface of the substrate (the second surface is usually a light incident surface), which avoids the adsorption of the optical film of the present invention with other films or elements. The resin coating of the present invention has good static resistance and high hardness, so that it can prevent the optical film from being scratched or damaged during transportation or manufacturing process and from dust adhering. Moreover, the resin coating of the present invention is capable of scattering light and can improve the moiré phenomenon resulting from the regular arrangement of optical films, eliminate bright and dark stripes and achieve the uniformity of light. As compared to the conventional technology in which spherical particles are used, the resin coating of the present invention uses non-spherical particles and due to the configuration of non-spherical particles, the thickness of the coating and the adhesion or aggregation of particles can be reduced, and thereby the resultant optical film has better light transmittance and luminance.

The following examples are used to further illustrate the present invention, but not intended to limit the scope of the present invention. Any modifications or alterations that can be easily accomplished by persons skilled in the art fall within the scope of the disclosure of the specification and the appended claims.

### EXAMPLES

### Preparation of UV Curable Resin A

In a 250 mL glass bottle, a solvent of 40 g toluene was added. Acrylate monomers comprising 10 g of dipentaerythritol hexaacrylate, 2 g of trimethylolpropane triacrylate and 14 g of pentaerythritol triacrylate, oligomers (28 g of aliphatic urethane hexaacrylate [Etercure 6145-100, Eternal Company]), and a photo initiator (6 g of 1-hydroxy cyclohexyl phenyl ketone) were added sequentially while stirring at a high speed; and finally, about 100 g of UV curable resin A with a solids content of about 60% was prepared.

### Preparation of Coating Composition A

In a 250 mL glass bottle, a solvent of 34.1 g butanone was added. 0.59 g of non-spherical acrylic resin particles [LMX series, Japan Sekisui Plastics Company] having an average particle size in the longest dimension of 6 μm and an aspect ratio of 1.2 to 1.8, 32.7 g of the UV curable resin A, 32.7 g of a thermal setting resin: an acrylate resin [Eterac® 7365-S-30, Eternal Company] with a solids content of about 30%, and 0.6 g of an anti-static agent [GMB-36M-AS, Marubishi Oil Chem. Co., Ltd] (with a solids content of about 20%) were sequentially added while stirring at a high speed; and finally, about 100 g of Coating Composition A with a solids content of about 30% was prepared.

### Preparation of Coating Composition B

In a 250 mL glass bottle, a solvent of 35.0 g butanone was added. 1.42 g of non-spherical acrylic resin particles [LMX series, Japan Sekisui Plastics Company] having an average particle size in the longest dimension of 6 μm and an aspect ratio of 1.2 to 1.8, 31.7 g of the UV curable resin A, 31.7 g of a thermal setting resin: an acrylate resin [Eterac® 7365-S-30, Eternal Company] with a solids content of about 30%, and 0.6 g of an anti-static agent [GMB-36M-AS, Marubishi Oil Chem. Co., Ltd] (with a solids content of about 20%) were sequentially added while stirring at a high speed; and finally, about 100 g of Coating Composition B with a solids content of about 30% was prepared.

### Preparation of Coating Composition C

In a 250 mL glass bottle, a solvent of 34.1 g butanone was added. 0.59 g of spherical acrylic resin particles [SSX-105, Japan Sekisui Plastics Company] having an average particle size of 5 μm, 32.7 g of the UV curable resin A, 32.7 g of a thermal setting resin: an acrylate resin [Eterac® 7365-S-30, Eternal Company] with a solids content of about 30%, and 0.6 g of an anti-static agent [GMB-36M-AS, Marubishi Oil Chem. Co., Ltd] (with a solids content of about 20%) were sequentially added while stirring at a high speed; and finally, about 100 g of Coating Composition C with a solids content of about 30% was prepared.

### Preparation of Coating Composition D

In a 250 mL glass bottle, a solvent of 34.1 g butanone was added. 0.59 g of spherical acrylic resin particles [SSX-108, Japan Sekisui Plastics Company] having an average particle size of 8 μm, 32.7 g of the UV curable resin A, 32.7 g of a thermal setting resin: an acrylate resin [Eterac® 7365-S-30, Eternal Company] with a solids content of about 30%, and 0.6 g of an anti-static agent [GMB-36M-AS, Marubishi Oil Chem. Co., Ltd] (with a solids content of about 20%) were sequentially added while stirring at a high speed; and finally, about 100 g of Coating Composition D with a solids content of about 30% was prepared.

### Example 1

Coating Composition A was applied onto one surface of a transparent PET substrate having a thickness of 188 μm [U34, Toray Company] by a RDS Bar Coater #5, dried at 80° C. for 1 minute, and exposed to a UV exposure machine [Fusion UV, F600V, 600 WInch, H type lamp source] at a power set at 100% and at a speed of 15 m/min with an energetic ray of 200 mJ/cm², to afford a resin coating. Upon a thickness test, the resultant film has a total film thickness of about 190.2 μm.

### Example 2

Coating Composition B was applied onto one surface of a transparent PET substrate having a thickness of 188 μm [U34, Toray Company] by a RDS Bar Coater #5, and then dried and cured under the conditions as described in Example 1, to afford a resin coating on the substrate. Upon a thickness test, the resultant film has a total film thickness of about 190.2 μm.

### Comparative Example 3

Coating Composition C was applied onto one surface of a transparent PET substrate having a thickness of 188 μm [U34, Toray Company] by a RDS Bar Coater #5, and then dried and cured under the conditions as described in Example 1, to afford a resin coating on the substrate. Upon a thickness test, the resultant film has a total film thickness of about 190.7 μm.

### Comparative Example 4

Coating Composition D was applied onto one surface of a transparent PET substrate having a thickness of 188 μm [U34, Toray Company] by a RDS Bar Coater #5, and then dried and cured under the conditions as described in Example 1, to afford a resin coating on the substrate. Upon a thickness test, the resultant film has a total film thickness of about 190.3 μm.

### Example 5

Coating Composition A was applied onto the light incident surface of a diffusive film having a thickness of 213 μm [Eterac® DI-780A, Eternal Company] by a RDS Bar Coater #5, and then dried and cured under the conditions as described in Example 1, to afford a resin coating on the substrate. Upon a thickness test, the resultant film has a total film thickness of about 215.2 μm.

### Comparative Example 6

Coating Composition C was applied onto the light incident surface of a diffusive film having a thickness of 213 μm [Eterac® DI-780A, Eternal Company] by a RDS Bar Coater #5, and then dried and cured under the conditions as described in Example 1, to afford a resin coating on the substrate. Upon a thickness test, the resultant film has a total film thickness of about 215.7 μm.

### Comparative Example 7

Coating Composition D was applied onto the light incident surface of a diffusive film having a thickness of 213 μm [Eterac® DI-780A, Eternal Company] by a RDS Bar Coater #5, and then dried and cured under the conditions as described in Example 1, to afford a resin coating on the substrate. Upon a thickness test, the resultant film has a total film thickness of about 215.3 μm.

### Example 8

Coating Composition A was applied onto the light incident surface of a prism film having a thickness of 213 μm [Eterac® PF-962-188, Eternal Company] by a RDS Bar Coater #5, and then dried and cured under the conditions as described in Example 1, to afford a resin coating on the substrate. Upon a thickness test, the resultant film has a total film thickness of about 215.2 μm.

### Comparative Example 9

Coating Composition C was applied onto the light incident surface of a prism film having a thickness of 213 μm [Eterac® PF-962-188, Eternal Company] by a RDS Bar Coater #5, and then dried and cured under the conditions as described in Example 1, to afford a resin coating on the substrate. Upon a thickness test, the resultant film has a total film thickness of about 215.7 μm.

### Comparative Example 10

Coating Composition D was applied onto the light incident surface of a prism film having a thickness of 213 μm [Eterac® PF-962-188, Eternal Company] by a RDS Bar Coater #5, and then dried and cured under the conditions as described in Example 1, to afford a resin coating on the substrate. Upon a thickness test, the resultant film has a total film thickness of about 215.3 μm.

### Test Method A:

Film Thickness Test: The film thickness of the samples was measured with a coating thickness gauge (PIM-100, TESA Corporation) under 1 N pressing contact.

Brightness Test: According to JIS K7136 standard method, the samples were measured for a haze (Hz) and total transmittance (Tt) with a NDH 5000W Haze Meter (Nippon Denshoku Industries Co., Ltd.). The results are listed in Table 1 below.

Pencil Hardness Test: According to JIS K-5400 method, the samples were tested with a Pencil Hardness Tester [Elcometer 3086, SCRATCH BOY], using Mitsubishi pencils (2H, 3H). The results are listed in Table 1 below.

Surface Resistivity Test: The surface resistivity of the samples was measured with a Superinsulation Meter [EASTASIA TOADKK Co., SM8220&SME-8310, 500 V]. The testing conditions were: 23±2° C., 55±5% RH. The results are listed in Table 1 below.

Surface Roughness Test: The surface roughness (Ra) and maximum distance of peak to valley (Rz) of the samples were measured with a Surface Roughness Tester [Mitsutoyo Company, Surftest SJ-201] according to JIS B-0601 method. The results are listed in Table 1 below.

Scratch Resistance Test: A Linear Abraser [TABER 5750] was used, and the film to be tested (20 mm length×20 mm width) was affixed on a 350 g platform (area: 20 mm length×20 mm width). A diffuser plate [EMS-55G, Entire Technology Co., Ltd] was used to test the anti-compression ability and scratch resistance between the resin coating of the film and the diffuser plate. The test was performed in 10 cycles with a test path of 2 inch and a speed of 10 cycle/min. The results of the test are listed in Table 1 below.

TABLE 1

| | | | Comparative | Comparative |
|---|---|---|---|---|
| | Example 1 | Example 2 | Example 3 | Example 4 |
| Amount of the | 0.59 | 1.42 | 0.59 | 0.59 |
| Particles (wt %) | | | | |
| Thickness of the | 2.2 | 2.2 | 2.7 | 2.3 |
| Resin Coating (μm) | | | | |
| Pencil Hardness | OK | OK | OK | OK |
| (3H) | | | | |
| Surface Resistivity | 5.9 × 10¹² | 9.5 × 10¹² | 2.0 × 10¹³ | 1.1 × 10¹³ |
| (Ω/□) | | | | |
| Hz (%) | 3.74 | 11.95 | 11.47 | 12.50 |
| Tt (%) | 91.48 | 90.90 | 90.31 | 90.43 |
| Scratch Resistance | No Scratch | No Scratch | Severe Scratch | Severe Scratch |
| of the Resin | | | | |
| Coating | | | | |
| Scratch Resistance | No Scratch | No Scratch | Severe Scratch | Severe Scratch |
| of the Diffuser | | | | |
| Plate | | | | |
| Surface Roughness | 0.44 | 0.46 | 0.44 | 0.63 |
| Ra (μm) | | | | |
| Maximum Distance | 3.15 | 3.00 | 3.22 | 4.98 |
| of Peak to Walley | | | | |
| Rz (μm) | | | | |

It can be seen from the results of Example 1 and Comparative Example 3 that the resin coatings of Example 1 and Comparative Example 3 have the same surface roughness; however, the resin coating of Example 1 uses non-spherical particles, has better scratch resistance, and does not scratch the diffuser plate.

It can be seen from the results of Example 1 and Comparative Examples 3 and 4 that when the particles are added in a same amount, the coating resin of Example 1 has better scratch resistance and static resistance, thereby preventing the substrate from dust adsorption and scratches.

It can be seen from the results of Examples 1 and 2 that by increasing the amount of the particles contained in the resin coating, the haze of the film is increased from 3.74% to 11.95% while the total transmittance of the film is maintained at more than 90%.

It can be seen from the results of Example 2 and Comparative Examples 3 and 4 that when controlling the haze of the films at similar levels, the film of Example 2 has better scratch resistance and does not scratch the diffuser plate; and the total transmittance and static resistance of the film of Example 2 are better than those of the films of Comparative Examples 3 and 4 even if the film of Example 2 contains a higher amount of particles.

### Testing Method B:

Luminance Measurement Method: The film was assembled on a backlight module [19″ W liquid crystal display, CMV937A, Chi Mei Optoelectronics], and then a portable luminance meter [K-10, KLEIN company] was used to measure luminance of the film. The testing conditions were: 23±2° C., 55±5% RH. The size of the module (L×W) is 42 cm×26 cm and the test position was: (0.5 L, 0.5 W).

Test 1: The films obtained in Example 5 and Comparative Examples 6 and 7 were respectively assembled above a light guide of a backlight module [19″ W liquid crystal display, CMV937A, Chi Mei Optoelectronics], and then subjected to luminance measurements. The results of the test are listed in Table 2 below.

TABLE 2

| | Luminance | Luminance |
|---|---|---|
| | (cd/m²) | Gain (%) |
| Example 5 | 3508.4 | 100.9 |
| Comparative Example 6 | 3492.7 | 100.4 |
| Comparative Example 7 | 3478.8 | 100.0 |

It can be seen from the results of Example 5 and Comparative Examples 6 and 7 that since the coating resin of the film of Comparative Example 7 contain bigger spherical particles, the luminance obtained is not as good as those of the films of Example 5 and Comparative Example 6. The particles used in the films of Example 5 and Comparative Example 6 have similar particle size. However, the film of Example 5 uses non-spherical particles, thereby achieving higher luminance and luminance gain.

Test 2: The films obtained in Example 8 and Comparative Examples 9 and 10, each together with a diffusive film [Etertac® DI-780A, Eternal Company], were respectively assembled above a light guide of a backlight module [19″ W liquid crystal display, CMV937A, Chi Mei Optoelectronics], and then subjected to luminance measurements. The results of the test are listed in Table 3 below.

TABLE 3

| | Luminance | Luminance |
|---|---|---|
| | (cd/m²) | Gain (%) |
| Example 8 | 4202.0 | 101.4 |
| Comparative Example 9 | 4162.0 | 100.5 |
| Comparative Example 10 | 4142.0 | 100.0 |

As compared to Comparative Examples 9 and 10 in which spherical particles are used, the film of Example 8 uses non-spherical particles and achieves higher luminance and luminance gain.

### CONCLUSION

According to the results shown in Tables 1 to 3, the resin coating of the present invention uses non-spherical particles and provides good scratch resistance and static resistance.

What is claimed is:

1. An optical film, comprising:
(a) a flexible substrate,
(b) a first surface comprising a convex-concave microstructure, and
(c) a second surface comprising a resin coating, wherein the resin coating comprises non-spherical particles and the non-spherical particles have a longest dimension in the range from 1 μm to 20 μm and an aspect ratio in the range from 1.2 to 1.8.

2. The optical film as claimed in claim 1, wherein the non-spherical particles have a longest dimension in the range from 2 μm to 12 μm.

3. The optical film as claimed in claim 2, wherein the non-spherical particles have a longest dimension in the range from 3 μm to 8 μm.

4. The optical film as claimed in claim 1, wherein the resin coating has a thickness of 0.5 μm to 10 μm.

5. The optical film as claimed in claim 4, wherein the resin coating has a thickness of 1 μm to 5 μm.

6. The optical film as claimed in claim 1, wherein the non-spherical particles are polyacrylate resin, polystyrene resin, polyurethane resin, silicone resin, or a mixture thereof.

7. The optical film as claimed in claim 6, wherein the non-spherical particles are polyacrylate resin.

8. The optical film as claimed in claim 1, wherein the resin coating is smooth.

9. The optical film as claimed in claim 1, wherein the resin coating is non-smooth.

10. The optical film as claimed in claim 1, wherein the resin coating comprises non-spherical particles and a binder, and the non-spherical particles are present in an amount from about 0.1 to about 30 parts by weight per 100 parts by weight of the solids content of the binder.

11. The optical film as claimed in claim 10, wherein the non-spherical particles are present in an amount from about 1 to about 5 parts by weight per 100 parts by weight of the solids content of the binder.

12. The optical film as claimed in claim 1, wherein the resin coating further comprises an additive selected from the group consisting of an anti-static agent, a curing agent, a photo initiator, a fluorescent whitening agent, a UV absorber, inorganic particulates, a wetting agent, a defoamer, a leveling agent, a flow agent, a slipping agent, a dispersant, and a stabilizing agent.

13. The optical film as claimed in claim 1, wherein the binder contained in the resin coating is selected from the group consisting of an ultraviolet (UV) curable resin, a thermal setting resin, and a thermal plastic resin, and a mixture thereof.

14. The optical film as claimed in claim 13, wherein the UV curable resin is formed from at least one acrylic monomer or acrylate monomer having one or more functional groups.

15. The optical film as claimed in claim 14, wherein the acrylate monomer is selected from the group consisting of a methacrylate monomer, an acrylate monomer, a urethane acrylate monomer, a polyester acrylate monomer and an epoxy acrylate monomer.

16. The optical film as claimed in claim 13, wherein the thermal setting resin is selected from the group consisting of a hydroxyl and/or carboxyl group-containing polyester resin, epoxy resin, polymethacrylate resin, polyamide resin, fluoro resin, polyimide resin, polyurethane resin, alkyd resin, and a mixture thereof.

17. The optical film as claimed in claim 13, wherein the thermal plastic resin is selected from the group consisting of polyester resins, polymethacrylate resins, and a mixture thereof.

18. The optical film as claimed in claim 1, wherein the first surface is formed integrally with the substrate.

19. The optical film as claimed in claim 1, wherein the first surface is formed on the substrate by coating.

20. An optical film, which comprises:
(a) a flexible substrate,
(b) a first surface comprising a convex-concave microstructure, and
(c) a second surface comprising a resin coating, wherein the resin coating comprises non-spherical particles, a binder and an anti-static agent, and wherein the non-spherical particles have a longest dimension in the range from 3 μm to 8 μm and an aspect ratio in the range from 1.2 to 1.8 and the resin coating has a thickness of 1 μm to 5 μm and a pencil hardness of 3H or more as measured according to JIS K5400 standard method.

21. The optical film as claimed in claim 20, wherein the non-spherical particles have an aspect ratio in the range from 1.4 to 1.6.

22. The optical film as claimed in claim 20, wherein the resin coating has a surface resistivity in the range from 10⁸ to 10¹³Ω/□.

23. The optical film as claimed in claim 20, wherein the non-spherical particles are disk-like particles, rice-like particles, oval particles, capsule-like particles, or biconvex lenses-shaped particles.

24. The optical film as claimed in claim 20, wherein the non-spherical particles are biconvex lenses-shaped particles.

25. The optical film as claimed in claim 20, wherein the resin coating has a haze in the range from 1% to 90% as measured according to JIS K7136 standard method.

26. The optical film as claimed in claim 25, wherein the resin coating has a haze in the range from 5% to 50% as measured according to JIS K7136 standard method.

27. The optical film as claimed in claim 20, wherein the optical film has a total transmittance no less than 60%.
